(19) United States
(12) Patent Application Publication
(10) Pub. No.: US 2025/0065652 A1
(43) Pub. Date: Feb. 27, 2025

(54) PRINTING APPARATUS

(71) Applicant: SEIKO EPSON CORPORATION, Tokyo (JP)

(72) Inventors: Keita HANAWA, MATSUMOTO-SHI (JP); Manabu KONDO, MATSUMOTO-SHI (JP)

(21) Appl. No.: 18/808,443

(22) Filed: Aug. 19, 2024

(30) Foreign Application Priority Data
Aug. 22, 2023 (JP) 2023-134477

(51) Int. Cl. B41J 25/308; B41J 3/407; B41J 11/06; B41J 29/00

(52) U.S. Cl. CPC B41J 25/308; B41J 3/4078; B41J 11/06; B41J 29/00

(57) ABSTRACT

A printing apparatus includes a medium support unit including a support surface configured to support a medium, a head configured to eject liquid, a first moving unit configured to move the head in a first direction, a second moving unit configured to move the head in a second direction, a position adjusting unit configured to adjust a distance between the head and the support surface, a first interference detection unit configured to detect interference with the head, and a second interference detection unit configured to detect interference with the head. The first interference detection unit and the second interference detection unit are linked to the movement of the head in the second direction. The first interference detection unit is provided further on one side than the head in the second direction. The second interference detection unit is provided further on the other side than the head in the second direction.

The present application is based on, and claims priority from JP Application Serial Number 2023-134477, filed Aug. 22, 2023, the disclosure of which is hereby incorporated by reference herein in its entirety.

### BACKGROUND

### 1. Technical Field

The present disclosure relates to a printing device.

### 2. Related Art

For example, JP-A-2003-311938 discloses a printing apparatus that performs printing on a medium such as a T-shirt. In such a printing apparatus, it is possible to move the medium from the outside of a housing to the inside of the housing by moving a medium support unit, on which the medium is placed, in the horizontal direction, after the medium is placed on a support surface of the medium support unit on the outside of the housing. With this, after the medium is placed on the support surface on the outside of the housing, it is possible to perform printing on the medium that is moved from the outside of the housing to the inside of the housing. Further, such a printing apparatus includes an interference detection unit that detects interference with a head as the medium support unit moves.

However, such a printing apparatus is configured such that the medium support unit moves from the outside to the inside of the housing with the medium placed on the support surface. This has led to the enlargement of the printing apparatus. In view of this, it is desired to increase the reliability of the detection of the interference with the head even in the case where the printing apparatus is downsized.

### SUMMARY

For solving the above-described problems, a printing apparatus includes a medium support unit including a support surface configured to support a medium, a head configured to eject liquid to the medium supported by the support surface, a first moving unit configured to move the head in a first direction parallel to the support surface, a second moving unit configured to move the head in a second direction, the second direction being parallel to the support surface and intersecting the first direction, a position adjusting unit configured to adjust a distance between the head and the support surface in a third direction intersecting the support surface, a first interference detection unit configured to detect interference with the head, and a second interference detection unit configured to detect interference with the head. The first interference detection unit and the second interference detection unit are linked to movement of the head in the second direction, the first interference detection unit is provided further on one side than the head in the second direction, and the second interference detection unit is provided further on the other side than the head in the second direction.

### BRIEF DESCRIPTION OF THE DRAWINGS

FIG. 1 is a perspective view illustrating a printing apparatus.

FIG. 2 is a perspective view illustrating the printing apparatus.

FIG. 3 is a perspective view illustrating the printing apparatus.

FIG. 4 is a top view illustrating the printing apparatus.

FIG. 5 is a front view illustrating the printing apparatus.

FIG. 6 is a perspective view illustrating the printing apparatus.

FIG. 7 is a side view illustrating the printing apparatus.

FIG. 8 is a side view illustrating the printing apparatus.

FIG. 9 is a side view illustrating the printing apparatus.

FIG. 10 is a block diagram illustrating an electrical configuration of the printing apparatus.

FIG. 11 is a flowchart illustrating printing control processing.

FIG. 12 is a flowchart illustrating interference detection processing.

FIG. 13 is a flowchart illustrating the interference detection processing.

FIG. 14 is a flowchart illustrating the interference detection processing.

### DESCRIPTION OF EMBODIMENTS

### First Embodiment

An embodiment of a printing device will be described below. In the following description, a direction intersecting a vertical direction Z is referred to as a width direction X, and a direction intersecting the vertical direction Z and the width direction X is referred to as a front-rear direction Y. One side in the width direction X is referred to as a first width direction X1, and the other side in the width direction X is referred to as a second width direction X2. One side in the front-rear direction Y is referred to as a front side Y1, and the other side in the front-rear direction Y is referred to as a rear side Y2. The upward direction in the vertical direction Z is the upper side Z1, and the downward direction in the vertical direction Z is the lower side 22. The width direction X corresponds to an example of a first direction. The first width direction X1 corresponds to an example of one direction in the first direction, and the second width direction X2 corresponds to an example of the other direction in the first direction. The front-rear direction Y corresponds to an example of a second direction. The front side Y1 corresponds to an example of one direction in the second direction. The rear side Y2 corresponds to the other direction in the second direction an example. The vertical direction Z corresponds to an example of a third direction.

### Printing Apparatus 10

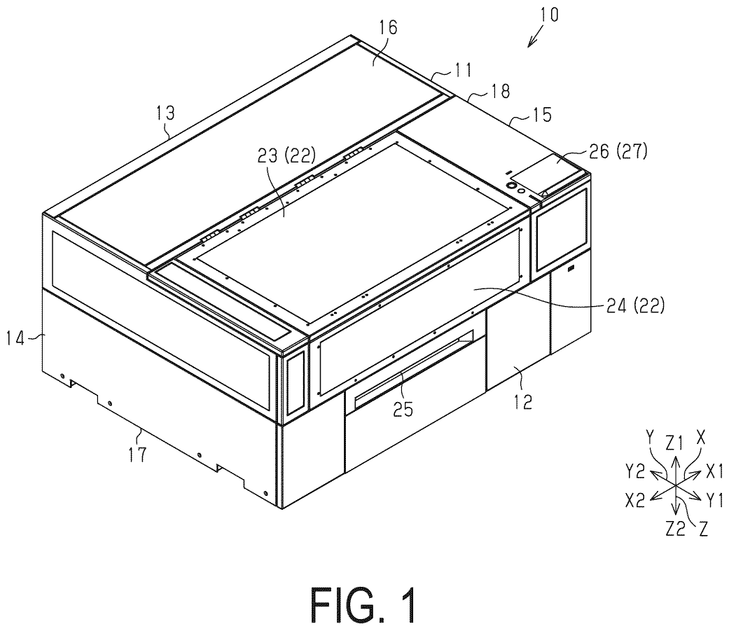

A printing apparatus 10 is configured to perform printing on a medium, as illustrated in FIG. 1. The printing apparatus 10 may be configured to perform printing on a medium by ejecting a liquid. The printing apparatus 10 may be configured to perform printing on a flexible medium, such as a T-shirt. The printing apparatus 10 may be configured such that a medium is placed in the interior thereof by a user.

### Housing 11

The printing apparatus 10 includes a housing 11. The housing 11 may have a rectangular shape. The housing 11 includes a front surface 12 facing the front side Y1. The housing 11 includes a back surface 13 facing the rear side Y2. The housing 11 includes a left side surface 14 facing the second width direction X2. The housing 11 includes a right side surface 15 facing the first width direction X1. The housing 11 includes a top surface 16 facing the upper side Z1. The housing 11 includes a bottom surface 17 facing the lower side Z2.

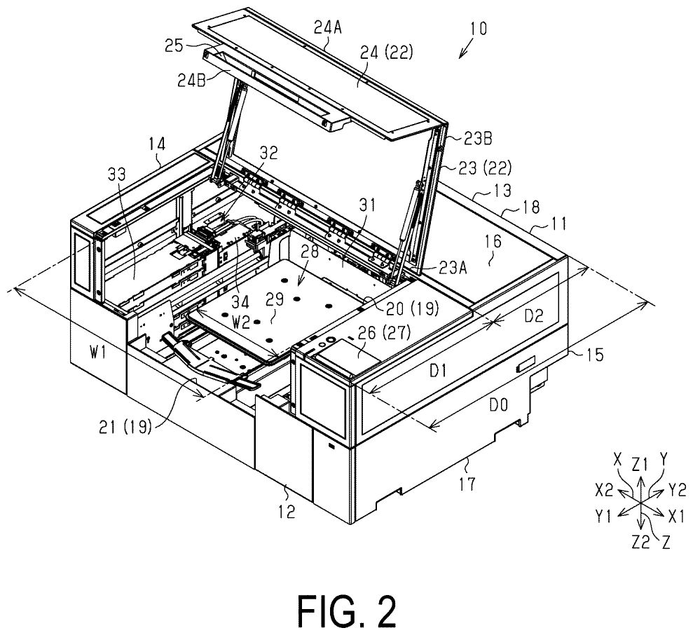

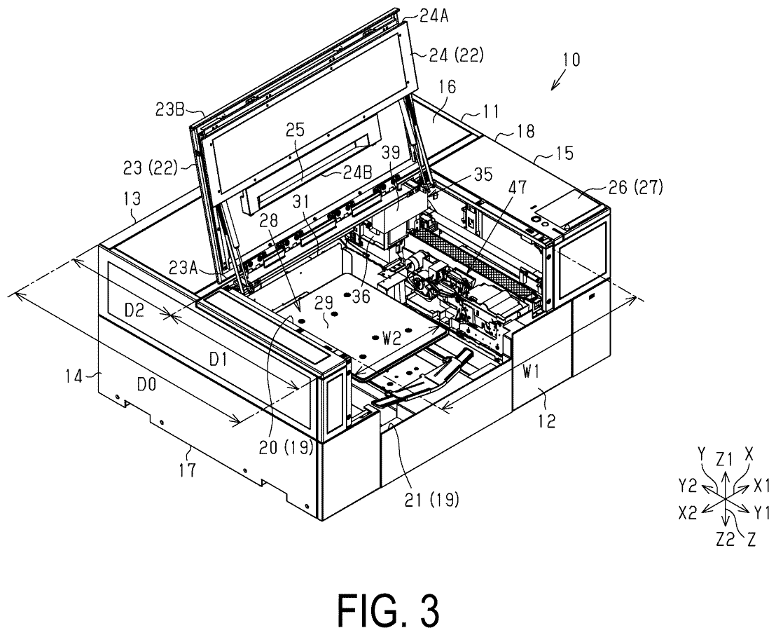

As illustrated in FIG. 2 and FIG. 3, the housing 11 is configured to accommodate various members included in the printing apparatus 10. In particular, the housing 11 accommodates a medium support unit 28, a liquid supply unit 32, a printing unit 35, and a maintenance unit 47, which are described later.

The housing 11 includes a housing frame 18. The housing frame 18 constitutes an exterior of the housing 11. The housing frame 18 includes an opening 19. In other words, the housing 11 includes the opening 19. The opening 19 is configured to expose the various members accommodated in the housing 11. In particular, the opening 19 is configured to expose a support surface 29 of the medium support unit 28, which is described later.

The opening 19 includes a first opening 20 and a second opening 21. The first opening 20 is provided at the top surface 16. The second opening 21 is provided at the front surface 12. The first opening 20 and the second opening 21 are provided so as to be continuous with each other. In other words, the opening 19 is provided across the top surface 16 and the front surface 12.

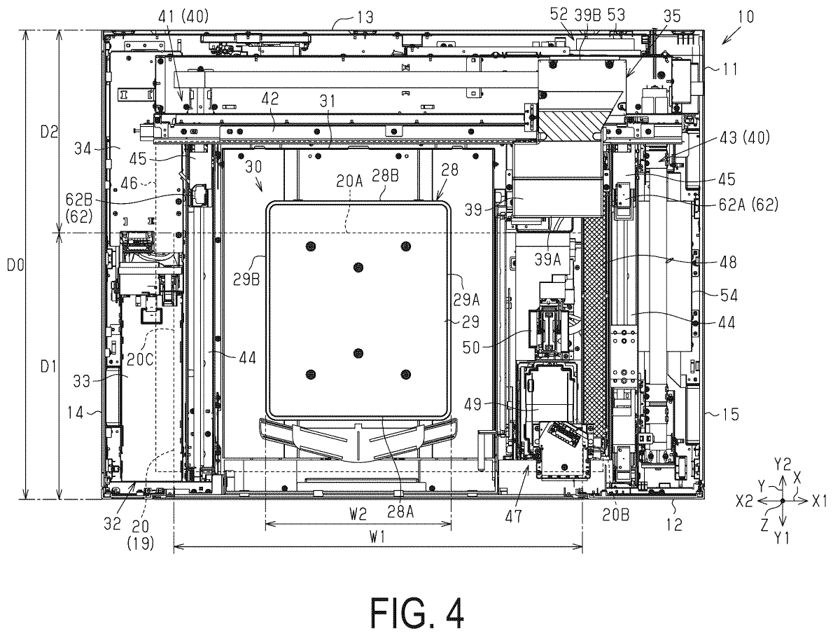

As illustrated in FIG. 4, in plan view, the first opening 20 is open between the front surface 12 and a first position 20A in the front-rear direction Y. The first position 20A is a position separated from the front surface 12 to the rear side Y2 by a first distance D1. The first position 20A is a position separated from the back surface 13 by a second distance D2. The first distance D1 is longer than the second distance D2. In other words, the first position 20A is closer to the back surface 13 than to the front surface 12 in the front-rear direction Y. When a distance between the front surface 12 and the back surface 13 in the front-rear direction Y is denoted by D0, the first distance DI is longer than half of the distance D0.

In plan view, the first opening 20 is open between a second position 20B and a third position 20C in the width direction X. In plan view, the first opening 20 is open over a first width W1 in the width direction X. The first width W1 is longer than a second width W2 of the support surface 29. In this way, when viewed from the upper side Z1, the first opening 20 has a rectangular shape longer than the support surface 29 in the width direction X.

In particular, when viewed from the upper side Z1, the second position 20B is located further to the first width direction X1 side than a first side end 29A of the support surface 29. The first side end 29A is an end of the support surface 29 in the first width direction X1. When viewed from the upper side Z1, the third position 20C is located further to the second width direction X2 side than a second side end 29B of the support surface 29. The second side end 29B is an end of the support surface 29 in the second width direction X2. As described above, when viewed from the upper side Z1, the first opening 20 is open to positions on the outside of the first side end 29A and the second side end 29B in the width direction X.

As illustrated in FIG. 2 and FIG. 3, the housing 11 includes an opening/closing cover 22. The opening/closing cover 22 is capable of opening and closing the opening 19. The opening/closing cover 22 may be constituted by a sheet metal to secure rigidity. The opening/closing cover 22 includes a first opening/closing cover 23. The first opening/closing cover 23 has a flat plate shape. The first opening/closing cover 23 is capable of opening and closing the first opening 20.

The opening/closing cover 22 includes a second opening/closing cover 24. The second opening/closing cover 24 has a flat plate shape. The second opening/closing cover 24 is capable of opening and closing the second opening 21. The second opening/closing cover 24 includes a grip portion 25. The grip portion 25 can be gripped by the user. The grip portion 25 is provided on a second end 24B of the second opening/closing cover 24 to be described later.

The printing apparatus 10 includes a display unit 26 and an operation unit 27. The display unit 26 is configured to display information. The operation unit 27 is configured to be operable by the user. The display unit 26 and the operation unit 27 may be integrally configured as a touch panel, or may be separately configured. The display unit 26 and the operation unit 27 are provided on the top surface 16, but are not limited thereto.

### Medium Support Unit 28

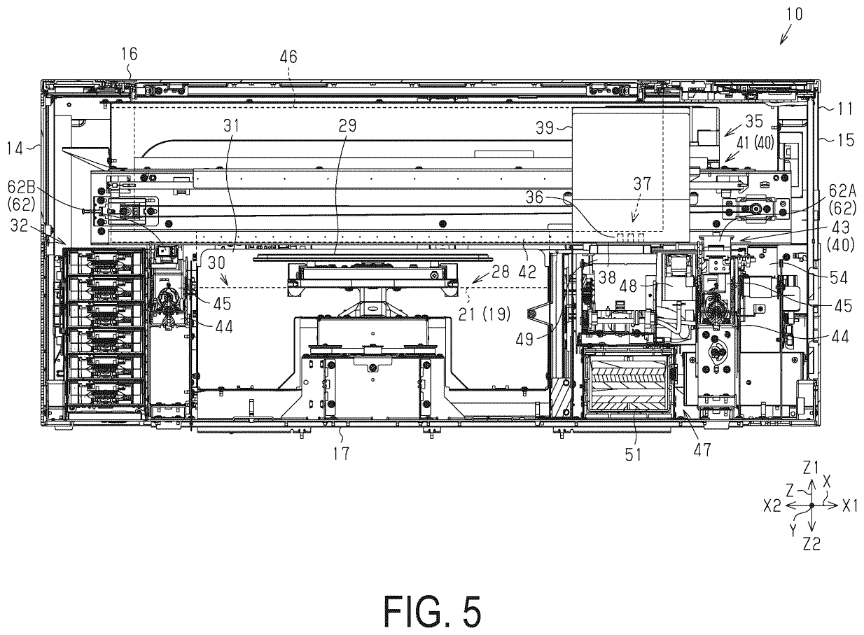

As illustrated in FIG. 4 and FIG. 5, the printing apparatus 10 includes the medium support unit 28. The medium support unit 28 is configured to support the medium. The medium support unit 28 includes a front end 28A and a rear end 28B. The front end 28A is an end of the medium support unit 28 on the front side Y1. The rear end 28B is an end of the medium support unit 28 on the rear side Y2.

The medium support unit 28 includes the support surface 29. The support surface 29 is a surface facing the upper side Z1. The support surface 29 is configured to support the medium. In particular, the support surface 29 is the surface that supports at least a printing region of the medium.

The medium support unit 28 is configured not to move in the horizontal direction parallel to the support surface 29. In other words, the support surface 29 is configured not to move in the horizontal direction. The medium support unit 28 is capable of adjusting the position of the support surface 29 in the vertical direction Z.

The printing apparatus 10 includes a medium accommodation unit 30. The medium accommodation unit 30 is accommodated in the housing 11. The medium accommodation unit 30 is provided in at least the width direction X of the support surface 29, and may also be provided in the front-rear direction Y. When a partial region of the medium is supported by the support surface 29, the medium accommodation unit 30 is capable of accommodating a partial region of the medium that is not supported by the support surface 29.

In particular, the medium accommodation unit 30 includes an accommodation tray 31. The medium accommodation unit 30 includes regions partitioned by the accommodation tray 31. The accommodation tray 31 may define the medium accommodation unit 30 at least on the rear side Y2 of the support surface 29.

### Liquid Supply Unit 32

The printing apparatus 10 includes the liquid supply unit 32. The liquid supply unit 32 is provided further in the second width direction X2 than the medium support unit 28 and the medium accommodation unit 30. The liquid supply unit 32 may be provided along an inner wall surface of the left side surface 14. The liquid supply unit 32 is configured to supply the liquid to a head 36, which is described later.

The liquid supply unit 32 includes a liquid storage unit 33 and a liquid supply driving unit 34. The liquid storage unit 33 is configured to store the liquid supplied to the head 36. The liquid storage unit 33 may be a detachable cartridge, or may be a tank that can be replenished with the liquid. The top surface of the liquid storage unit 33 may be a flat surface.

The liquid supply driving unit 34 is driven to supply the liquid stored in the liquid storage unit 33 to the head 36. The liquid supply driving unit 34 may include a liquid supply pump. The top surface of the liquid supply driving unit 34 may be a flat surface.

### Printing Unit 35

The printing apparatus 10 includes the printing unit 35. The printing unit 35 is configured to perform printing on the medium. In particular, the printing unit 35 is configured to perform printing on the medium supported by the support surface 29.

The printing unit 35 includes the head 36. In other words, the printing apparatus 10 includes the head 36. The head 36 is capable of ejecting the liquid onto the medium supported by the support surface 29. The head 36 includes a plurality of nozzles 37 and a nozzle surface 38. The nozzle surface 38 is a surface facing the lower side Z2. The nozzle surface 38 is a surface at which each of the plurality of nozzles 37 opens. Each of the plurality of nozzles 37 is capable of ejecting the liquid.

The printing unit 35 includes a carriage 39. In other words, the printing apparatus 10 includes the carriage 39. The carriage 39 is configured to support the head 36. The head 36 is configured as a serial type. The carriage 39 is movable in the width direction X. In the serial type, printing is performed while the head 36 moves in the width direction X. The carriage 39 includes one end 39A and the other end 39B. The one end 39A is an end on the front side Y1. The other end 39B is an end on the rear side Y2.

The printing unit 35 includes a moving unit 40. The moving unit 40 is configured to move the carriage 39. In other words, the moving unit 40 is configured to move the head 36. The moving unit 40 is configured to move the head 36 in the horizontal direction. Specifically, the moving unit 40 is configured to move the head 36 in the width direction X and the front-rear direction Y.

The moving unit 40 includes a first moving unit 41. In other words, the printing apparatus 10 includes the first moving unit 41. The first moving unit 41 is configured to move the carriage 39 in the width direction X. In other words, the first moving unit 41 is configured to move the head 36 in the width direction X.

The first moving unit 41 includes a first guide portion 42. The first guide portion 42 is configured to extend in the width direction X over the support surface 29. The first guide portion 42 guides the carriage 39 so as to be movable along the width direction X. The first guide portion 42 may be a guide frame that supports the carriage 39.

The moving unit 40 includes a second moving unit 43. In other words, the printing apparatus 10 includes the second moving unit 43. The second moving unit 43 is configured to support the first moving unit 41. The second moving unit 43 is configured to move the first moving unit 41 in the front-rear direction Y. In other words, the second moving unit 43 is configured to move the head 36 in the front-rear direction Y.

In addition, the second moving unit 43 is configured to move a first interference detection unit 62 and a second interference detection unit 63 described later in the front-rear direction Y. In other words, the second moving unit 43 is configured to move the first interference detection unit 62 and the second interference detection unit 63 described later in the front-rear direction Y together with the head 36.

The second moving unit 43 includes a pair of second guide portions 44. The pair of second guide portions 44 are provided in the first width direction X1 and the second width direction X2 of the medium support unit 28, with the medium support unit 28 interposed therebetween. Each of the pair of second guide portions 44 is configured to extend in the front-rear direction Y.

The second moving unit 43 includes a pair of support portions 45. The pair of support portions 45 are provided in the first width direction X1 and the second width direction X2 of the medium support unit 28, with the medium support unit 28 interposed therebetween. Each of the pair of support portions 45 is configured to support the first moving unit 41. The pair of support portions 45 are movable in the front-rear direction Y along the corresponding pair of second guide portions 44. In this manner, the moving unit 40 carries the head 36, and is movable in the horizontal direction over the medium support unit 28. The moving unit 40 is configured in a gate shape in a front view.

As illustrated in FIG. 4, the moving unit 40 can move the head 36 in a movement range 46. The movement range 46 of the head 36 includes a facing position and retracted positions. The facing position is a position at which the nozzle surface 38 faces the support surface 29. The retracted positions are positions at which the nozzle surface 38 does not face the support surface 29. The retracted positions include a standby position. The standby position is a position at which the head 36 is arranged when printing is not performed. The standby position is an initial position before a print command is received. In other words, the head 36 can standby in the standby position. The standby position may be located on the first width direction X1 side and the rear side Y2 side in the movement range 46. In this manner, the standby position is located on the first width direction X1 side of the support surface 29, and on the rear side Y2 of the support surface 29. Further, the retracted positions include a maintenance position. The maintenance position is a position at which the nozzle surface 38 faces the maintenance unit 47, which is described later. In other words, the movement range 46 of the head 36 includes the maintenance position.

### Maintenance Unit 47

The printing apparatus 10 includes the maintenance unit 47. The maintenance unit 47 is provided on the first width direction X1 side than the medium support unit 28 and the medium accommodation unit 30. The maintenance unit 47 is arranged at a position that does not overlap with the medium support unit 28 and the medium accommodation unit 30 in the vertical direction Z. The maintenance unit 47 is configured to perform maintenance of the head 36.

The maintenance unit 47 includes a flushing portion 48. The flushing portion 48 is configured to receive the liquid ejected from the head 36. The flushing portion 48 is configured to extend in the front-rear direction Y. However, the flushing portion 48 may be movable in the front-rear direction Y to face the nozzle surface 38. The flushing portion 48 is arranged at a position that does not overlap with the medium support unit 28 and the medium accommodation unit 30 in the vertical direction Z.

The maintenance unit 47 includes a wiping portion 49. The wiping portion 49 can wipe the nozzle surface 38. The wiping portion 49 is arranged at a position that does not overlap with the medium support unit 28 and the medium accommodation unit 30 in the vertical direction Z.

The maintenance unit 47 includes a suction portion 50. The suction portion 50 is configured to suck the liquid from the head 36. The suction portion 50 may include a suction pump that sucks the liquid from the head 36. The suction portion 50 is arranged at a position that does not overlap with the medium support unit 28 and the medium accommodation unit 30 in the vertical direction Z.

As illustrated in FIG. 5, the maintenance unit 47 includes a waste liquid tank 51. The waste liquid tank 51 is configured to store the liquid received by the flushing portion 48. The waste liquid tank 51 is configured to store the liquid sucked by the suction portion 50. The waste liquid tank 51 is arranged at a position that does not overlap with the medium support unit 28 and the medium accommodation unit 30 in the vertical direction Z. The waste liquid tank 51 is arranged at a position overlapping with the flushing portion 48 in the vertical direction Z. The waste liquid tank 51 is arranged at a position overlapping with the wiping portion 49 in the vertical direction Z. The waste liquid tank 51 is arranged at a position overlapping with the suction portion 50 in the vertical direction Z.

As illustrated in FIGS. 4 and 5, the printing apparatus 10 includes the first interference detection unit 62. The first interference detection unit 62 detects the presence/absence of the interfering object that can interfere with the head 36 on slightly lower side Z2 than the nozzle surface 38 of the head 36. In other words, the first interference detection unit 62 is configured to detect interference with the head 36.

The first interference detection unit 62 is supported by the second moving unit 43. The first interference detection unit 62 is linked to the movement of the head 36 in the front-rear direction Y. The first interference detection unit 62 is located on the front side Y1 than the head 36. In this manner, the first interference detection unit 62 is moved by the second moving unit 43 to the front side Y1 together with the head 36, and thus the first interference detection unit 62 is capable of detecting the interference with the head 36 before the object actually interferes with the head 36.

The first interference detection unit 62 includes a first light emission unit 62A and a first light reception unit 62B. The first light emission unit 62A is provided on the first width direction X1 side than the support surface 29. The first light reception unit 62B is provided on the second width direction X2 side than the support surface 29. The first light emission unit 62A and the first light reception unit 62B may be provided at the pair of respective support portions 45. In this manner, the first interference detection unit 62 detects the interference with the head 36 based on whether the light emitted from the first light emission unit 62A has been received by the first light reception unit 62B.

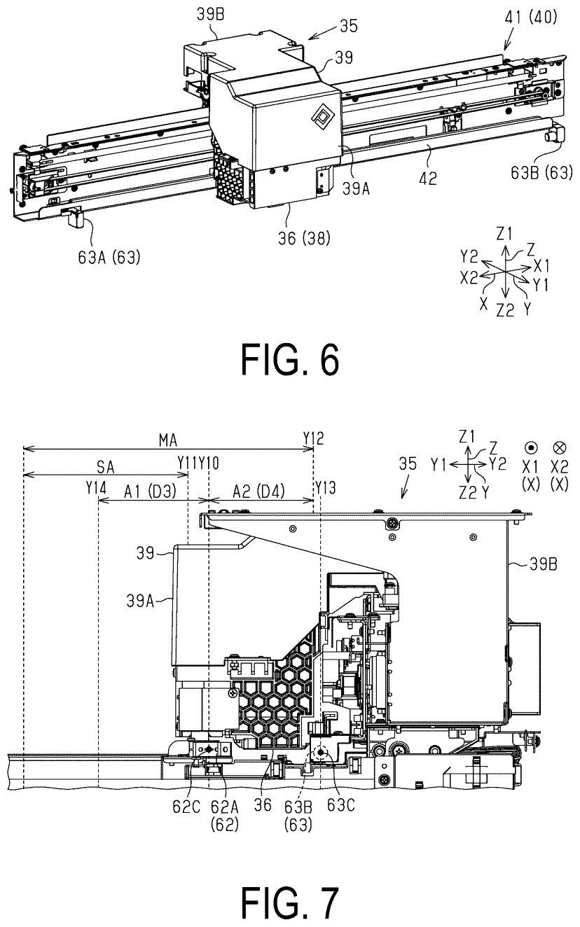

As illustrated in FIG. 6, the printing apparatus 10 includes the second interference detection unit 63. The second interference detection unit 63 detects the presence/absence of the interfering object that can interfere with the head 36 on slightly lower side Z2 than the nozzle surface 38 of the head 36. In other words, the second interference detection unit 63 is configured to detect interference with the head 36.

The second interference detection unit 63 is supported by the first guide portion 42. The first guide portion is supported by 42 the second moving unit 43. In other words, the second interference detection unit 63 is supported by the second moving unit 43. The second interference detection unit 63 is linked to the movement of the head 36 in the front-rear direction Y. The second interference detection unit 63 is located on the rear side Y2 than the head 36. In this manner, the second interference detection unit 63 is moved by the second moving unit 43 to the rear side Y2 together with the head 36, and thus the second interference detection unit 63 is capable of detecting the interference with the head 36 before the object actually interferes with the head 36.

The second interference detection unit 63 includes a second light emission unit 63A and a second light reception unit 63B. The second light emission unit 63A is provided on the second width direction X2 side than the support surface 29. The second light reception unit 63B is provided on the first width direction X1 side than the support surface 29. In this manner, the second interference detection unit 63 detects the interference with the head 36 based on whether the light emitted from the second light emission unit 63A has been received by the second light reception unit 63B.

### Control Board 52 and Power Supply Unit 54

As illustrated in FIG. 4, the printing apparatus 10 includes a control board 52. The control board 52 is accommodated in the housing 11. The control board 52 may be provided along the inner wall surface of the back surface 13. The control board 52 is a board on which various electronic components for controlling the printing apparatus 10 are mounted.

The control board 52 includes a control unit 53. In other words, the printing apparatus 10 includes the control unit 53. The control unit 53 controls the printing apparatus 10. The control unit 53 controls various operations performed by the printing apparatus 10. The control unit 53 may be configured as a circuit including a: one or more processors that perform various processes according to a computer program, B: one or more dedicated hardware circuits that perform at least some of the various processes, or y: a combination thereof. The hardware circuit is an application-specific integrated circuit, for example. The processor includes a CPU and a memory such as a RAM and a ROM, and the memory stores program codes or commands configured to cause the CPU to execute processing. The memory, i.e., a computer readable medium includes any readable mediums that can be accessed by general-purpose or dedicated computers.

The printing apparatus 10 includes a power supply unit 54. The power supply unit 54 is housed in the housing 11. The power supply unit 54 may be provided along the inner wall surface of the right side surface 15. The power supply unit 54 is configured to supply power to the printing apparatus 10.

### Positional Relationship of Interference Detection Units 62 and 63

Now positional relationships of the head 36, the carriage 39, the first interference detection unit 62 and the second interference detection unit 63 are described with reference to FIGS. 7 to 9.

As illustrated in FIG. 7, the first interference detection unit 62 is provided between one end 39A and the other end 39B of the carriage 39 in the front-rear direction Y. Specifically, the first interference detection unit 62 is provided at a position on the front side Y1 than the head 36 in the front-rear direction Y, and on the rear side Y2 than one end 39A of the carriage 39 in the front-rear direction Y. An optical axis 62C of the first interference detection unit 62 is provided at a position on the front side Y1 than the head 36 in the front-rear direction Y, and on the rear side Y2 than one end 39A of the carriage 39 in the front-rear direction Y.

The second interference detection unit 63 is provided between one end 39A and the other end 39B of the carriage 39 in the front-rear direction Y. Specifically, the second interference detection unit 63 is provided at a position on the rear side Y2 than the head 36 in the front-rear direction Y, and on the front side Y1 than the other end 39B of the carriage 39 in the front-rear direction Y. An optical axis 63C of the second interference detection unit 63 is provided at a position on the rear side Y2 than the head 36 in the front-rear direction Y, and on the front side Y1 than the other end 39B of the carriage 39 in the front-rear direction Y.

In addition, the optical axis 63C of the second interference detection unit 63 may be lower than the optical axis 62C of the first interference detection unit 62 in the vertical direction Z. In other words, the distance between the optical axis 63C of the second interference detection unit 63 and the support surface 29 in the vertical direction Z may be smaller than the distance between the optical axis 62C of the first interference detection unit 62 and the support surface 29 in the vertical direction Z.

As illustrated in FIG. 7, when the head 36 is arranged at a standby position, the optical axis 62C of the first interference detection unit 62 is arranged at a first reference position Y10 in the front-rear direction Y. The first reference position Y10 is a position on the rear side Y2 than a rear end position Y11 in the front-rear direction Y. The rear end position Y11 is a position corresponding to the rear end 28B of the medium support unit 28 in the front-rear direction Y. The region on the front side Y1 than the rear end position Y11 is a support region SA where the medium can be supported at the support surface 29.

The first reference position Y10 is located on the front side Y1 than a medium accommodation position Y12 in the front-rear direction Y. The medium accommodation position Y12 is a position where the medium placed on the medium support unit 28 can be accommodated. The medium accommodation position Y12 is a position corresponding to the accommodation tray 31 in the front-rear direction Y. The region on the front side Y1 than the medium accommodation position Y12 is a medium accommodation region MA where the medium can be accommodated. In the medium accommodation region MA, the medium placed on the medium support unit 28 can be located even when it is not the support region SA.

In this manner, when the head 36 is arranged at a standby position, the optical axis 62C of the first interference detection unit 62 is located on the rear side Y2 than the support surface 29, and on the front side Y1 than the accommodation tray 31.

When the head 36 is arranged at a standby position, the optical axis 63C of the second interference detection unit 63 is arranged at a position Y13 on the rear side Y2 than the medium accommodation position Y12 in the front-rear direction Y. In this manner, when the head 36 is arranged at a standby position, the optical axis 63C of the second interference detection unit 63 is located on the rear side Y2 than the accommodation tray 31.

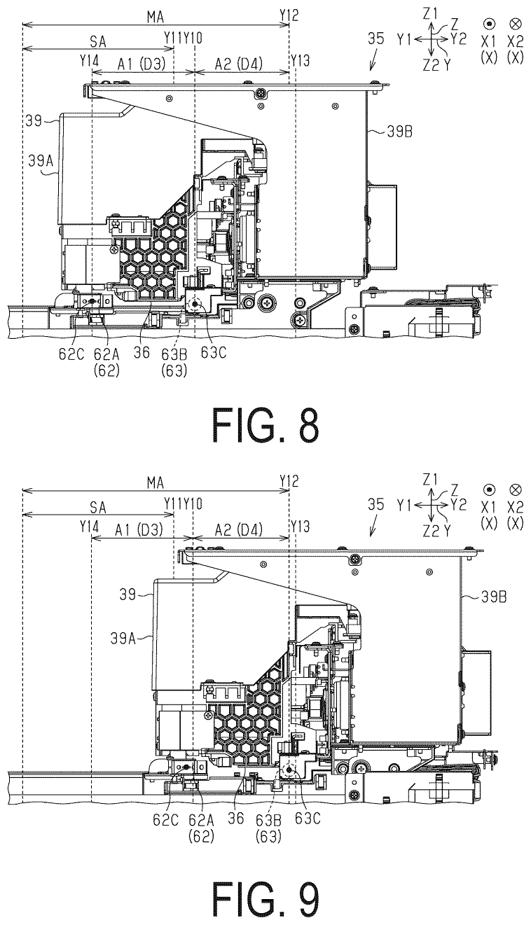

As illustrated in FIG. 8, when the interference with the head 36 is to be detected, the head 36 moves toward the front side Y1 from the standby position to a first initial movement position. The first initial movement position is a position on the front side Y1 than the standby position. When the head 36 moves from the standby position to the first initial movement position, the first interference detection unit 62 is capable of detecting the interference with the head 36 prior to the movement of the head 36 to the front side Y1.

When the head 36 is arranged at the first initial movement position, the optical axis 62C of the first interference detection unit 62 is located at a second reference position Y14. The second reference position Y14 is a position on the front side Y1 than the rear end position Y11 in the front-rear direction Y. In this manner, when the head 36 is arranged at the first initial movement position, the optical axis 62C of the first interference detection unit 62 is located on the front side Y1 than the rear end position Y11. In addition, when the head 36 is arranged at the first initial movement position, the optical axis 62C of the first interference detection unit 62 is located at the support region SA.

When the head 36 is arranged at the first initial movement position, the optical axis 63C of the second interference detection unit 63 is located at the first reference position Y10. In this manner, when the head 36 is arranged at the first initial movement position, the optical axis 63C of the second interference detection unit 63 is located on the rear side Y2 than the support surface 29, and on the front side Y1 than the accommodation tray 31.

In other words, when the head 36 moves from the standby position to the first initial movement position, the optical axis 62C of the first interference detection unit 62 moves over a first region A1. In this manner, the first interference detection unit 62 is capable of detecting the interference with the head 36 in the first region A1.

The first region A1 is a region between the first reference position Y10 and the second reference position Y14. The first region A1 is included in the medium accommodation region MA. A part of the first region A1 is included in the support region SA. The first reference position Y10 and the second reference position Y14 are separated from each other by a distance D3 in the front-rear direction Y.

As illustrated in FIG. 9, when the interference with the head 36 is to be detected, the head 36 moves toward the rear side Y2 from the first initial movement position to a second initial movement position. The second initial movement position is a position on the front side Y1 than the standby position, and a position on the rear side Y2 than the first initial movement position. In other words, the second initial movement position is a position between the standby position and the first initial movement position. When the head 36 moves from the first initial movement position to the second initial movement position, the second interference detection unit 63 is capable of detecting the interference with the head 36 prior to the movement of the head 36 to the rear side Y2.

When the head 36 is arranged at the second initial movement position, the optical axis 62C of the first interference detection unit 62 is located on the rear side Y2 than the rear end position Y11 in the front-rear direction Y, and on the front side Y1 than the medium accommodation position Y12 in the front-rear direction Y.

When the head 36 is arranged at the second initial movement position, the optical axis 63C of the second interference detection unit 63 is located at the medium accommodation position Y12 in the front-rear direction Y. When the head 36 is arranged at the second initial movement position, the optical axis 63C of the second interference detection unit 63 is located at the rear end of the medium accommodation region MA.

In other words, when the head 36 moves from the first initial movement position to the second initial movement position, the optical axis 63C of the second interference detection unit 63 moves over a second region A2. In this manner, the second interference detection unit 63 is capable of detecting the interference with the head 36 in the second region A2.

The second region A2 is a region between the first reference position Y10 and the medium accommodation position Y12. The second region A2 is included in the medium accommodation region MA. The second region A2 is included in the support region SA. The first reference position Y10 and the medium accommodation position Y12 are separated from each other by a distance D4 in the front-rear direction Y.

When the interference with the head 36 is to be detected, the head 36 moves toward the front side Y1 from the second initial movement position to a frontmost position. The frontmost position is a frontmost position on the front side Y1 when the head 36 moves to the front side Y1. When the head 36 moves from the second initial movement position to the frontmost position, the first interference detection unit 62 is capable of detecting the interference with the head 36 prior to the movement of the head 36 to the front side Y1.

When the head 36 is arranged at the frontmost position, the first interference detection unit 62 is located on the front side Y1 than the front end 28A of the medium support unit 28. In other words, when the head 36 is arranged at the frontmost position, the first interference detection unit 62 is located on the front side Y1 than the support region SA. In this manner, the first interference detection unit 62 is capable of detecting the interference with the head 36 in the support region SA. When the head 36 is arranged at the frontmost position, the second interference detection unit 63 may be located on the rear side Y2 than the front end 28A of the medium support unit 28.

### Electrical Configuration of Printing Apparatus 10

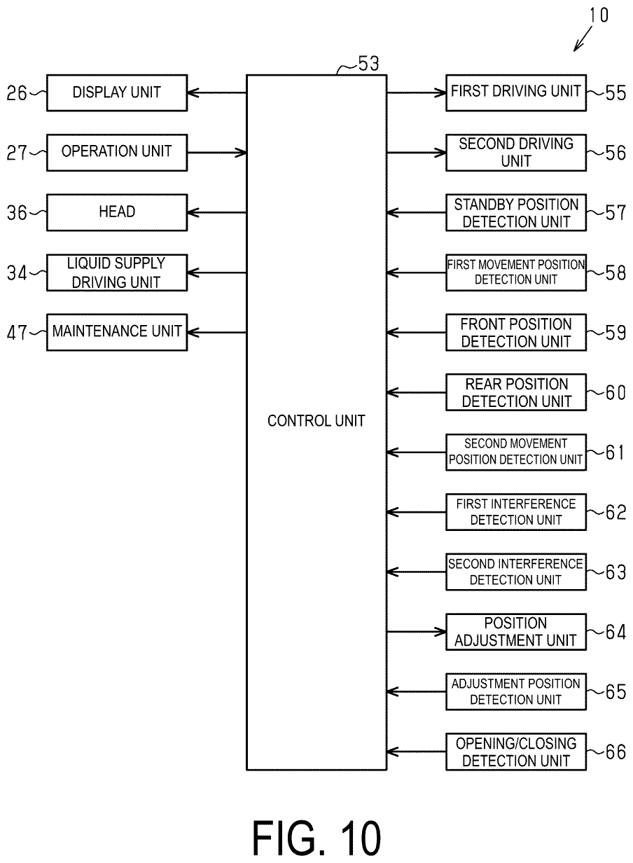

Next, with reference to FIG. 10, an electrical configuration of the printing apparatus 10 is described.

As illustrated in FIG. 10, the printing apparatus 10 includes a first driving unit 55. The first driving unit 55 is a driving source that moves the carriage 39 along the width direction X. The first driving unit 55 may be provided at the first moving unit 41.

The printing apparatus 10 includes a second driving unit 56. The second driving unit 56 is a driving source that moves the first moving unit 41 along the front-rear direction Y. The second driving unit 56 may be provided at the second moving unit 43.

The printing apparatus 10 includes a standby position detection unit 57. The standby position detection unit 57 is capable of detecting that the head 36 is arranged at the standby position. The standby position detection unit 57 may be provided at the first moving unit 41.

The printing apparatus 10 includes a first movement position detection unit 58. The first movement position detection unit 58 is capable of detecting the position in the width direction X at which the head 36 moving in the width direction X is arranged. The first movement position detection unit 58 may be provided at the first moving unit 41.

The printing apparatus 10 includes a front position detection unit 59. The front position detection unit 59 is capable of detecting that the head 36 is arranged at a front-most position. The front position detection unit 59 may be provided at the second moving unit 43.

The printing apparatus 10 includes a rear position detection unit 60. The rear position detection unit 60 is capable of detecting that the head 36 is arranged at a rear-most position. The rear position detection unit 60 may be provided at the second moving unit 43.

The printing apparatus 10 includes a second movement position detection unit 61. The second movement position detection unit 61 is capable of detecting a position in the front-rear direction Y at which the head 36 is arranged. The second movement position detection unit 61 may be provided at the second moving unit 43. In other words, the second movement position detection unit 61 detects the position of the head 36 in the front-rear direction Y. It can be said that the second movement position detection unit 61 detects the positions of the first interference detection unit 62 and the second interference detection unit 63 in the front-rear direction Y.

The printing apparatus 10 includes a position adjusting unit 64. The position adjusting unit 64 is configured to adjust the position of the support surface 29 in the vertical direction Z. In other words, the position adjusting unit 64 is configured to adjust the distance between the head 36 and the support surface 29 in the vertical direction Z. The position adjusting unit 64 may be provided at the medium support unit 28. The position adjusting unit 64 may be configured to adjust the position of the accommodation tray 31 in the vertical direction Z.

The printing apparatus 10 includes an adjustment position detection unit 65. The adjustment position detection unit 65 is capable of detecting the position of the support surface 29 in the vertical direction Z. In other words, the adjustment position detection unit 65 is configured to detect the distance between the support surface 29 and the nozzle surface 38. The adjustment position detection unit 65 may be provided at the medium support unit 28.

The printing apparatus 10 includes an opening/closing detection unit 66. The opening/closing detection unit 66 is capable of detecting the opening/closing state of the first opening/closing cover 23. In other words, the opening/closing detection unit 66 is capable of detecting the opening/closing state of the opening/closing cover 22. The opening/closing detection unit 66 is provided at the inner wall surface facing the top surface 16, but this is not limitative.

The control unit 53 is coupled to the display unit 26, the head 36, the first driving unit 55, the second driving unit 56, the position adjusting unit 64, the liquid supply driving unit 34 and the maintenance unit 47. The control unit 53 causes the display unit 26 to display various types of images. The control unit 53 controls the head 36, the first driving unit 55, the second driving unit 56, the position adjusting unit 64, the liquid supply driving unit 34 and the maintenance unit 47 by supplying driving signals. In particular, the control unit 53 controls the first moving unit 41 by controlling the first driving unit 55. The control unit 53 controls the second moving unit 43 by controlling the second driving unit 56.

The control unit 53 is coupled to the operation unit 27, the standby position detection unit 57, the first movement position detection unit 58, the front position detection unit 59, the rear position detection unit 60, the second movement position detection unit 61, the first interference detection unit 62, the second interference detection unit 63, the adjustment position detection unit 65 and the opening/closing detection unit 66. The control unit 53 is capable of receiving operation signals from the operation unit 27. The control unit 53 is capable of receiving detection signals from the standby position detection unit 57, the first movement position detection unit 58, the front position detection unit 59, the rear position detection unit 60, the second movement position detection unit 61, the first interference detection unit 62, the second interference detection unit 63, the adjustment position detection unit 65 and the opening/closing detection unit 66.

The control unit 53 performs various types of control, based on the operation signals and the detection signals. As a specific example, the control unit 53 may stop the printing when the opening/closing detection unit 66 detects that the opening/closing cover 22 has been opened during the printing operation.

### Printing Control Processing

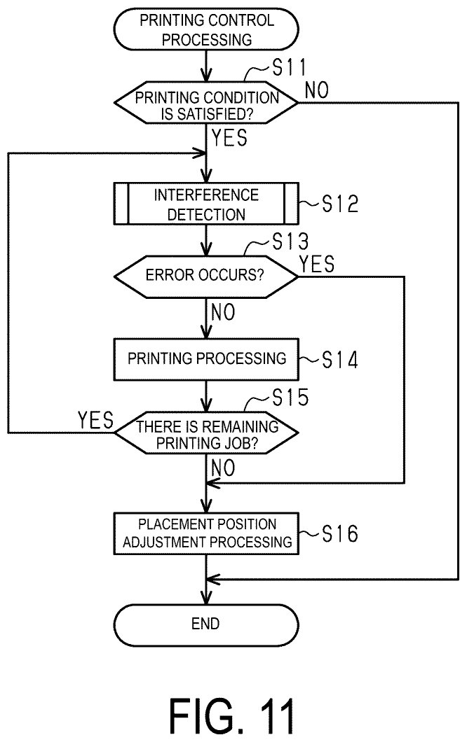

Now printing control processing is described with reference to FIG. 11. The printing control processing is processing executed by the control unit 53 at a predetermined period. Here, the order of the processing can be changed as desired insofar as it does not depart from the purpose of the processing.

As illustrated in FIG. 11, in step S11, the control unit 53 determines whether the printing condition is satisfied. In the processing, the control unit 53 determines that the print condition is satisfied by receiving a print command from the user when printing is not being performed. When the control unit 53 determines that the print condition is not satisfied, the control unit 53 terminates the printing control processing. On the other hand, when the control unit 53 determines that the printing condition is satisfied, the control unit 53 shifts the processing to step S12.

In step S12, the control unit 53 executes interference detection processing. As specifically described later, in this processing, the control unit 53 moves the first interference detection unit 62 and the second interference detection unit 63 in the front-rear direction Y together with the head 36. Then, the control unit 53 detects the interference with the head 36 on the basis of the detection result of the first interference detection unit 62 and the second interference detection unit 63. In particular, the control unit 53 moves the first interference detection unit 62 and the second interference detection unit 63 to the front side Y1 together with the head 36, and controls the position adjusting unit 64 to adjust the distance between the head 36 and the support surface 29 on the basis of the detection result of the first interference detection unit 62.

In step S13, the control unit 53 determines whether an error relating to the interference detection occur. The error relating to the interference detection may include an interference error. The interference error is an error when the interference with the head 36 is detected on the basis of the detection result of the first interference detection unit 62 and the second interference detection unit 63.

When the control unit 53 determines that the error relating to the interference detection has occurred, the control unit 53 terminates the printing control processing after executing error processing. The control unit 53 causes the display unit 26 to display an error image relating to an error in the error processing. In the error processing, the control unit 53 may control the first driving unit 55 and the second driving unit 56 to move the head 36 to the standby position, but is not limited thereto. On the other hand, when the control unit 53 determines that the error relating to the interference detection has not occurred, the control unit 53 shifts the processing to step S14.

In step S14, the control unit 53 executes printing processing. In the processing, the control unit 53 controls the first driving unit 55 so that the first moving unit 41 moves the head 36 in the width direction X, and also controls the head 36 to perform printing on the medium, based on image data included in the print command. With this, the control unit 53 performs printing by one pass. The control unit 53 controls the second driving unit 56 to move the head 36 to the rear side Y2 by a predetermined distance. In this manner, the control unit 53 performs printing for each pass by moving the head 36 in the width direction X and to the rear side Y2. Further, the control unit 53 controls the head 36 to move the head 36 to the rear side Y2 and in the width direction X until the head 36 reaches the rear-most position and to perform printing on the medium.

In step S15, the control unit 53 determines whether there is a remaining printing job for a subsequent layer, based on the print command from the user. For example, printing on a subsequent layer is performed after white base printing is performed on a medium as printing on a first layer. As printing on the first layer, a single-colored or multi-colored pattern or the like may be printed instead of white base printing. As printing on the subsequent layer, a single-colored or multi-colored pattern or the like may be printed, or white base printing may be performed again. Printing on a subsequent layer may be performed at a position overlapping with printing on the first layer or printing on another subsequent layer or a position not overlapping therewith.

When the control unit 53 determines that there is a remaining printing job, the control unit 53 shifts the processing to step S12 again. On the other hand, when the control unit 53 determines that there is no remaining printing job, the control unit 53 shifts the processing to step S16. In this manner, the control unit 53 is capable of executing steps S12 to S14 until it is determined that there is no remaining printing.

In step S16, the control unit 53 executes placement position adjustment processing. In this processing, the control unit 53 controls the position adjusting unit 64 to move the support surface 29 to the placement position by moving the support surface 29 to the upper side Z1. The placement position is a position for placing the medium at the medium support unit 28. The placement position may be a highest position. When the processing is completed, the control unit 53 terminates the printing control processing.

In this manner, the control unit 53 drives the position adjusting unit 64 such that the support surface 29 is set to the placement position when the driving condition is satisfied. The driving condition is satisfied when printing is not being performed, and the head 36 is arranged at the retracted position. In this manner, when printing is not being performed and the head 36 is arranged at the evacuation, the position adjusting unit 64 is capable of moving the support surface 29 to a position higher than the nozzle surface 38 in the vertical direction Z.

Further, the control unit 53 controls the head 36 and the maintenance unit 47 to perform flushing at a predetermined control period during execution of the printing control processing. In particular, the control unit 53 controls the head 36 and the maintenance unit 47 to perform flushing at a predetermined control period at least during execution of the interference detection processing. The predetermined control period may be several tens of seconds, for example.

### Interference Detection Processing

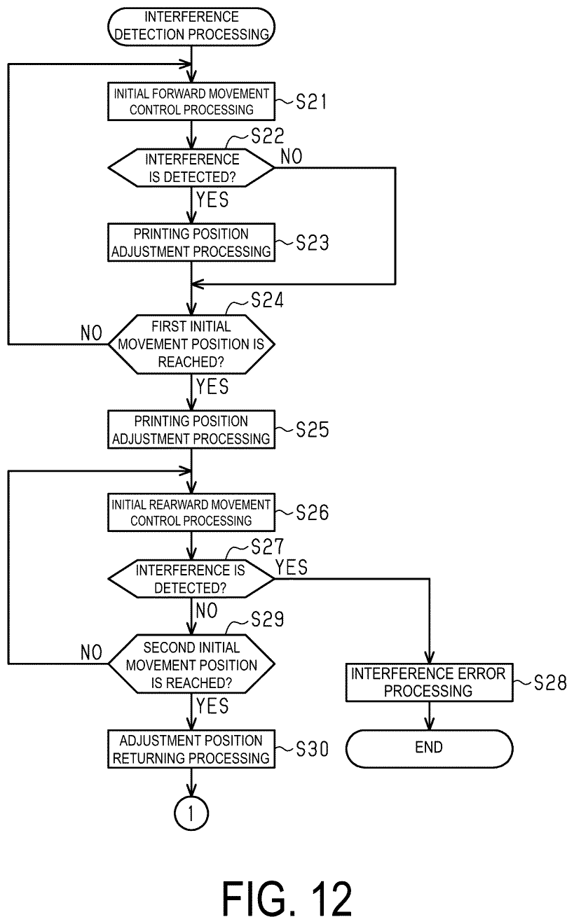

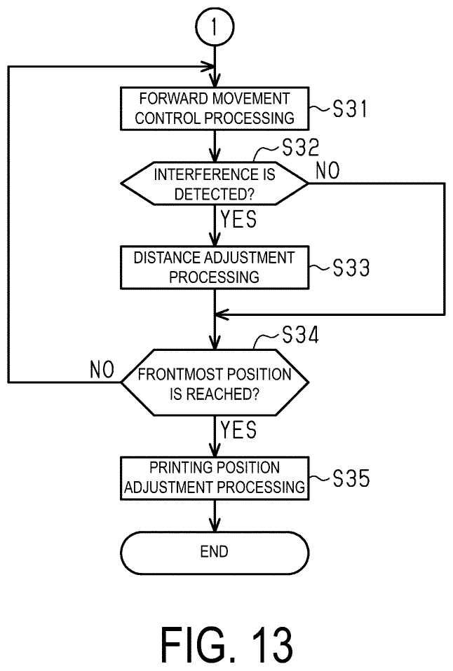

Next, with reference to FIGS. 12 and 13, interference detection processing is described. The interference detection processing is processing invoked by the control unit 53 in step S12.

As illustrated in FIG. 12, in step S21, the control unit 53 executes initial forward movement control processing. In the processing, the control unit 53 controls the second driving unit 56 to move the head 36 to the front side Y1.

In step S22, the control unit 53 determines whether the interference with the head 36 is detected on the basis of the detection signal from the first interference detection unit 62. When determining that the interference with the head 36 is not detected, the control unit 53 shifts the processing to step S24. On the other hand, when the control unit 53 determines that interference with the head 36 is detected, the control unit 53 shifts the processing to step S23.

In step S23, the control unit 53 executes distance adjustment processing. In this processing, the control unit 53 controls the position adjusting unit 64 to move the support surface 29 to the lower side Z2 to a position where the interference is not detected.

In step S24, the control unit 53 determines whether the head 36 has reached the first initial movement position on the basis of the detection signal from the second movement position detection unit 61. When determining that the head 36 has not reached the first initial movement position, the control unit 53 shifts the processing to step S21 again. On the other hand, when determining that the head 36 has reached the first initial movement position, the control unit 53 shifts the processing to step S25.

In this manner, the control unit 53 controls the position adjusting unit 64 to increase the distance between the support surface 29 and the head 36 when the first interference detection unit 62 detects the interference with the head 36 when the head 36 is moved to the front side Y1. In particular, by moving the head 36 from the standby position to the first initial movement position, the control unit 53 determines whether the interference with the head 36 is detected in the first region A1 on the basis of the detection result of the first interference detection unit 62. Then, the control unit 53 controls the position adjusting unit 64 such that the interference with the head 36 is not detected.

In step S25, the control unit 53 executes printing position adjustment processing. In this processing, the control unit 53 controls the position adjusting unit 64 to move the support surface 29 to the lower side Z2. In particular, the control unit 53 controls the position adjusting unit 64 to move the support surface 29 to the lower side Z2 by a prescribed distance. The prescribed distance is a distance that is prescribed as the printing position.

In step S26, the control unit 53 executes initial rearward movement control processing. In this processing, the control unit 53 controls the second driving unit 56 to move the head 36 to the rear side Y2.

In step S27, the control unit 53 determines whether the interference with the head 36 is detected on the basis of the detection signal from the second interference detection unit 63. When the control unit 53 determines that interference with the head 36 is detected, the control unit 53 shifts the processing to step S28. On the other hand, when the control unit 53 determines that interference with the head 36 is not detected, the control unit 53 shifts the processing to step S29.

In step S28, the control unit 53 executes an interference error processing. In this processing, the control unit 53 determines that there is an interference error. Specifically, when the head 36 is moved to the rear side Y2 and the second interference detection unit 63 detects the interference with the head 36, the control unit 53 determines that an interfering object that is not the medium placed on the support surface 29 is detected and that there is an interference error. When the processing is completed, the control unit 53 terminates the interference detection processing. In this manner, in step S13 in FIG. 11, the control unit 53 determines that an interference error has occurred.

In step S29, the control unit 53 determines whether the head 36 has reached the second initial movement position on the basis of the detection signal from the second movement position detection unit 61. When determining that the head 36 has not reached the second initial movement position, the control unit 53 shifts the processing to step S26 again. On the other hand, when determining that the head 36 has reached the second initial movement position, the control unit 53 shifts the processing to step S30.

In this manner, when the head 36 is moved to the rear side Y2 and the second interference detection unit 63 detects the interference with the head 36, the control unit 53 determines that there is an error. In particular, the control unit 53 determines whether the interference with the head 36 is detected in the second region A2 on the basis of the detection result of the second interference detection unit 63 by moving the head 36 from the first initial movement position to the second initial movement position. Then, when the interference with the head 36 is detected, the control unit 53 determines that there is an error.

In step S30, the control unit 53 executes adjustment position returning processing. In this processing, the control unit 53 controls the position adjusting unit 64 to move the support surface 29 to the upper side Z1. In particular, the control unit 53 controls the position adjusting unit 64 to move the support surface 29 to the upper side Z1 by a prescribed distance. In this manner, the support surface 29 moves to the height of the state before the adjustment in step S25.

As illustrated in FIG. 13, in step S31, the control unit 53 executes forward movement control processing. In this processing, the control unit 53 controls the second driving unit 56 to move the head 36 to the front side Y1.

In step S32, as in step S22 in FIG. 12, the control unit 53 determines whether the interference with the head 36 is detected on the basis of the detection signal from the first interference detection unit 62. When determining that the interference with the head 36 is not detected, the control unit 53 shifts the processing to step S34. On the other hand, when determining that the interference with the head 36 is detected, the control unit 53 shifts the processing to step S33.

In step S33, as in step S23 in FIG. 12, the control unit 53 executes the distance adjustment processing. In this processing, the control unit 53 controls the position adjusting unit 64 to move the support surface 29 to the lower side Z2 to a position where the interference is not detected.

In step S34, the control unit 53 determines whether the head 36 has reached the frontmost position on the basis of the detection signal from the front position detection unit 59. When determining that the head 36 has not reached the frontmost position, the control unit 53 shifts the processing to step S31 again. On the other hand, when determining that the head 36 has reached the frontmost position, the control unit 53 shifts the processing to step S35.

In this manner, the control unit 53 controls the position adjusting unit 64 to increase the distance between the support surface 29 and the head 36 when the first interference detection unit 62 detects the interference with the head 36 when the head 36 is moved to the front side Y1. In particular, the control unit 53 determines whether the interference with the head 36 is detected on the basis of the detection result of the first interference detection unit 62 by moving the head 36 from the second initial position to the frontmost position. Then, the control unit 53 controls the position adjusting unit 64 such that the interference with the head 36 is not detected.

In step S35, as in step S25 in FIG. 12, the control unit 53 executes the printing position adjustment processing. In this processing, the control unit 53 controls the position adjusting unit 64 to move the support surface 29 to the lower side Z2. In particular, the control unit 53 controls the position adjusting unit 64 to move the support surface 29 to the lower side 22 by a prescribed distance. In this manner, the control unit 53 controls the position adjusting unit 64 to move the support surface 29 to the printing position.

### Operations of First Embodiment

Operations of the first embodiment will be described.

In the printing apparatus 10, when the power source is turned on, the support surface 29 is arranged at the placement position in a state in which the head 36 is arranged at the standby position. In this manner, the support surface 29 moves up to be arranged at a position higher than the nozzle surface 38 in the vertical direction Z in the movement range 46 of the head 36. Specifically, when the printing is not being performed, the support surface 29 moves up to be arranged in the movement space of the head 36.

In the state in which the opening 19 is open and the support surface 29 is arranged at the placement position, the user can easily place the medium on the support surface 29 from the front side Y1. In this case, at least the printing region of the medium is supported by the support surface 29. Further, a partial region of the medium that is not supported by the support surface 29 is accommodated in the medium accommodation unit 30.

When a print command is input with the opening 19 closed, the head 36 moves toward the front side Y1 from the standby position to the first initial movement position. In this case, the first interference detection unit 62 moves to the front side Y1 in linkage with the movement of the head 36, and thus the interference with the head 36 can be detected over the first region A1. The position adjusting unit 64 moves the support surface 29 to the lower side Z2 until the interference with the head 36 is not detected on the basis of the detection result of the first interference detection unit 62. When no interference with the head 36 is detected after the movement from the standby position to the first initial movement position, the support surface 29 moves to the lower side Z2 by a prescribed distance.

Next, the head 36 moves toward the rear side Y2 from the first initial movement position to the second initial movement position. In this case, the second interference detection unit 63 moves to the rear side Y2 in linkage with the movement of the head 36, and thus the interference with the head 36 can be detected over the second region A2. When the interference with the head 36 is detected on the basis of the detection result of the second interference detection unit 63, it is determined that there is an interference error. When no interference with the head 36 is detected during the movement from the first initial movement position to the second initial movement position, the support surface 29 moves to the upper side Z1 by a prescribed distance.

Next, the head 36 moves toward the front side Y1 from the second initial movement position to the frontmost position. In this case, the first interference detection unit 62 moves to the front side Y1 in linkage with the movement of the head 36, and thus the interference with the head 36 can be detected in the medium accommodation region MA. The position adjusting unit 64 moves the support surface 29 to the lower side Z2 until the interference with the head 36 is not detected on the basis of the detection result of the first interference detection unit 62. When no interference with the head 36 is detected after the movement from the second initial movement position to the frontmost position, the support surface 29 moves to the lower side Z2 by a prescribed distance. In this manner, the support surface 29 moves to the printing position.

Subsequently, printing is performed in as the head 36 moves to the rear side Y2. With this, the printing unit 35 is capable of performing printing on the medium placed on the support surface 29 without the head 36 colliding with the support surface 29.

When the printing is completed, the support surface 29 moves from the printing position to the placement position in the state where the head 36 is arranged at a standby position. In this manner, when the printing is not being performed, the position adjusting unit 64 can adjust the position of the support surface 29 to the upper side Z1 than when the printing is being performed.

### Effects of First Embodiment

Effects of the first embodiment will be described.
(1-1) The first moving unit 41 moves the head 36 in the width direction X, and the second moving unit 43 moves the head 36 in the front-rear direction Y. In the related art, it is necessary for the tray to be moved to the outside of the housing in order to place the medium, and a mechanism for stably moving the tray to the outside of the housing is required, which causes an increase in the size of the printing apparatus. In view of this, with the above-mentioned configuration, printing can be performed on the medium by moving the head 36 in the width direction X and the front-rear direction Y parallel to the support surface 29, and it is not necessary to have the configuration of moving the medium support unit 28 in the width direction X and the front-rear direction Y. Accordingly, the size of the printing apparatus 10 can be reduced.
(1-2) In addition, the first interference detection unit 62 and the second interference detection unit 63 are linked to the movement of the head 36 in the front-rear direction Y. The first interference detection unit 62 is provided on the front side Y1 than the head 36. The second interference detection unit 63 is provided on the rear side Y2 than the head 36. In this manner, the first interference detection unit 62 is capable of detecting the interference with the head 36 in linkage with the movement of the head 36 to the front side Y1, whereas the second interference detection unit 63 is capable of detecting the interference with the head 36 in linkage with the movement of the head 36 to the rear side Y2. In particular, in the second region A2 where the interference with the head 36 cannot be detected with the first interference detection unit 62, the interference with the head 36 can be detected with the second interference detection unit 63. In this manner, even in the case where the size of the printing apparatus 10 is reduced, the reliability of detection of the interference with the head 36 can be increased.
(1-3) The first interference detection unit 62 is provided at a position on the front side Y1 than the head 36, and on the rear side Y2 than one end 39A of the carriage 39. The second interference detection unit 63 is provided at a position on the rear side Y2 than the head 36, and on the front side Y1 than the other end 39B of the carriage 39. With this configuration, between one end 39A and the other end 39B of the carriage 39 in the front-rear direction Y, the first interference detection unit 62 can be provided on the front side Y1 of the head 36, and the second interference detection unit 63 can be provided on the rear side Y2 of the head 36. In this manner, the first interference detection unit 62 and the second interference detection unit 63 can be provided within a range where the carriage 39 is present in the front-rear direction Y. In this manner, even in the case where the size of the printing apparatus 10 is reduced, the reliability of detection of the interference with the head 36 can be increased.
(1-4) The first light emission unit 62A is provided on the first width direction X1 side than the support surface 29, and the first light reception unit 62B is provided on the second width direction X2 side than the support surface 29. The second light emission unit 63A is provided on the second width direction X2 side than the support surface 29, and the second light reception unit 63B is provided on the first width direction X1 side than the support surface 29. With this configuration, the light emitted from the first light emission unit 62A to the first light reception unit 62B less easily enters the second light reception unit 63B, and the light emitted from the second light emission unit 63A to the second light reception unit 63B less easily enters the first light reception unit 62B. In this manner, the interference with the head 36 can be accurately detected. In this manner, even in the case where the size of the printing apparatus 10 is reduced, the reliability of detection of the interference with the head 36 can be increased.
(1-5) The distance between the optical axis 63C of the second interference detection unit 63 and the support surface 29 in the vertical direction Z is smaller than the distance between the optical axis 62C of the first interference detection unit 62 and the support surface 29 in the vertical direction Z. With this configuration, the detection of the interference with the head 36 with the second interference detection unit 63 can be performed at a timing earlier than the detection of the interference with the head 36 with the first interference detection unit 62. In this manner, the detection timing of the interference with the head 36 can be adjusted in accordance with the detection state. In this manner, even in the case where the size of the printing apparatus 10 is reduced, the reliability of detection of the interference with the head 36 can be increased.
(1-6) The first interference detection unit 62 and the second interference detection unit 63 are supported by the second moving unit 43. With this configuration, the interference with the head 36 can be accurately detected with a simple configuration. In this manner, even in the case where the size of the printing apparatus 10 is reduced, the reliability of detection of the interference with the head 36 can be increased.
(1-7) The control unit 53 controls the position adjusting unit 64 to increase the distance between the support surface 29 and the head 36 when the first interference detection unit 62 detects the interference with the head 36 when the head 36 is moved to the front side Y1. When the second interference detection unit 63 detects the interference with the head 36 when the head 36 is moved to the rear side Y2, the control unit 53 determines that there is an error. With this configuration, the distance between the head 36 and the medium can be adjusted by increasing the distance between the support surface 29 and the head 36 when the head 36 is moved to the front side Y1. On the other hand, the determination of an error can be achieved when the head 36 is moved to the rear side Y2. In this manner, the details of the control related to the detection of the interference with the head 36 can be adjusted in accordance with the detection state. In this manner, even in the case where the size of the printing apparatus 10 is reduced, the reliability of detection of the interference with the head 36 can be increased.
(1-8) When moving the head 36 from the first initial movement position to the second initial movement position, the control unit 53 moves the support surface 29 to the lower side Z2 by a prescribed distance. In this manner, by moving the head 36 from the first initial movement position to the second initial movement position in the state where the head 36 and the support surface 29 are at the printing position, the interference with the head 36 in the second region A2 can be detected assuming the post-printing state. In this manner, even in the case where the size of the printing apparatus 10 is reduced, the reliability of detection of the interference with the head 36 can be increased.
(1-9) The housing 11 includes the opening 19 for exposing the support surface 29. For this reason, it is possible to place the medium on the support surface 29 accommodated in the housing 11 from the outside of the housing 11 through the opening 19, and it is possible to improve the operability for the user.
(1-10) The housing 11 includes the opening/closing cover 22 that can open and close the opening 19. Thus, when the opening 19 is opened by the opening/closing cover 22, it is possible to place the medium on the support surface 29 accommodated in the housing 11 from the outside of the housing 11 through the opening 19, and operability for the user can thus be improved. On the other hand, when the opening 19 is closed by the opening/closing cover 22, it is possible to prevent a foreign matter from entering the inside of the housing 11 from the outside of the housing 11 through the opening 19.
(1-11) The opening 19 has a shape that is longer than the support surface 29 in the width direction X as viewed from the vertical direction Z. For this reason, when placing the medium on the support surface 29, handling of the medium in the width direction X becomes easy, and the operability for the user can thus be improved.
(1-12) In addition, the medium accommodation unit 30 is capable of accommodating a partial region of the medium that is not supported by the support surface 29. The medium support unit 28 is configured not to move in the direction parallel to the support surface 29. In this manner, printing can be performed on the medium by moving the head 36 in the width direction X and the front-rear direction Y parallel to the support surface 29, and it is not necessary to have the configuration of moving the medium support unit 28 in the width direction X and the front-rear direction Y. Accordingly, the size of the printing apparatus 10 can be reduced.
(1-13) The moving unit 40 is housed in the housing 11. Thus, the head 36 can be moved in the horizontal direction in the state in which the moving unit 40 is accommodated in the housing 11, and it is possible to change a relative positional relationship between the head 36 and the support surface 29 in the horizontal direction. With this, it is not necessary to provide a configuration for moving the support surface 29 in the direction parallel to the support surface 29. Accordingly, the size of the printing apparatus 10 can be reduced.
(1-14) The housing 11 accommodates the medium support unit 28 and the printing unit 35. When printing is not being performed and the head 36 is arranged at the retracted position where the nozzle surface 38 does not face the support surface 29, the position adjusting unit 64 is capable of moving the support surface 29 from the lower position to the higher position than the nozzle surface 38 in the vertical direction Z in the movement range 46 of the head 36. In this manner, even with the configuration in which the medium support unit 28 and the printing unit 35 are housed in the housing 11, it is not necessary to ensure the space for placing the medium outside the housing 11. Thus, the installation space of the printing apparatus 10 can be reduced.
(1-15) In addition, when the printing is not being performed and the head 36 is arranged at the evacuation position, the support surface 29 can be moved from the lower position to the higher position than the nozzle surface 38 in the vertical direction Z in the movement range 46 of the head 36. Thus, when placing the medium on the support surface 29, the support surface 29 can be moved to the height where the medium can be easily placed on support unit 28, which makes the handling of the medium easy, and can improve the operability of the user. Further, the installation space of the printing apparatus 10 can be reduced.
(1-16) The movement range 46 of the head 36 includes a position where the nozzle surface 38 faces the maintenance unit 47. Thus, it is possible to perform maintenance of the nozzle surface 38 by moving the nozzle surface 38 to the position facing the maintenance unit 47, and it is possible to suppress a decrease in printing quality.
(1-17) The maintenance unit 47 includes the flushing portion 48 that receives the liquid ejected from the head 36. Thus, by moving the nozzle surface 38 to the position facing the flushing portion 48, it is possible to receive the liquid ejected from the head 36, and it is possible to suppress a decrease in the printing quality.
(1-18) The maintenance unit 47 includes the wiping portion 49 that is capable of wiping the nozzle surface 38. Thus, it is possible to wipe the nozzle surface 38 by moving the nozzle surface 38 to the position facing the wiping portion 49, and it is possible to suppress a decrease in the printing quality.
(1-19) When printing is not being performed and the head 36 is arranged at the evacuation position, the position adjusting unit 64 is capable of moving the support surface 29 to a position higher than the nozzle surface 38 in the vertical direction Z. Therefore, when printing is not being performed and the head 36 is arranged at the retracted position, the support surface 29 can be moved to a position higher than the nozzle surface 38. Thus, when placing the medium on the support surface 29, the user can perform the operation at a position close to the user, using the first opening 20 in the housing 11. Therefore, handling of the medium becomes easy, and it is possible to improve operability for the user.

### Second Embodiment

Next, a second embodiment is described. In the following description, the same configurations as those in the exemplary embodiment described above are denoted with the same reference symbols, and redundant description therefor is omitted or simplified.

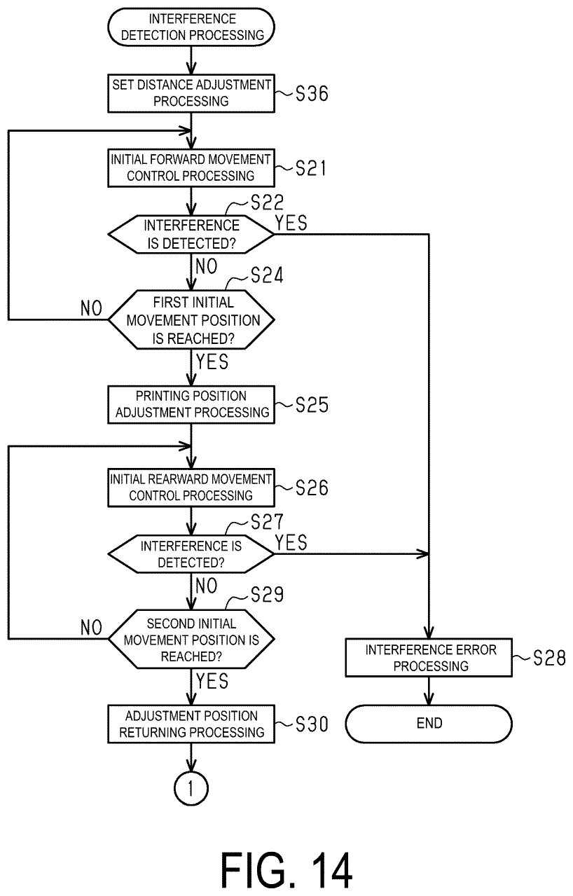

As illustrated in FIG. 14, in the interference detection processing, in step S36, the control unit 53 executes set distance adjustment processing. In this processing, the control unit 53 controls the position adjusting unit 64 to move the support surface 29 to the lower side Z2 to the set distance set by the user. When this processing is completed, the control unit 53 shifts the processing to step S21.

In step S22, when determining that the interference with the head 36 is not detected, the control unit 53 shifts the processing to step S24 without executing step S23. When determining that the interference with the head 36 is detected, the control unit 53 shifts the processing to step S28 without executing step S23. In this manner, when the first interference detection unit 62 detects the interference with the head 36 in the state where the support surface 29 is moved to the lower side Z2 to the set distance set by the user, the control unit 53 determines that there is an error. In this manner, the control unit 53 determines that there is an error when the first interference detection unit 62 detects the interference with the head 36 when the head 36 is moved to the front side Y1 in the state where the set distance is set by the user.

### Effects of Second Embodiment

Effects of the second embodiment will be described.
(2-1) The control unit 53 detects the interference with the head 36 with the first interference detection unit 62 in linkage with the movement of the head 36 to the front side Y1 in the state where the support surface 29 is moved to the lower side Z2 to the set distance set by the user. In this manner, in the state where the support surface 29 is moved to the lower side Z2 to the set distance intended by the user, the interference with the head 36 can be detected with the first interference detection unit 62. In this manner, even in the case where the size of the printing apparatus 10 is reduced, the reliability of detection of the interference with the head 36 can be increased.
(2-2) When the interference with the head 36 is detected with the first interference detection unit 62 in linkage with the movement of the head 36 to the front side Y1 in the state where the support surface 29 is moved to the lower side Z2 to the set distance intended by the user, the control unit 53 determines that there is an error. In this manner, by prioritizing determination of an error over the control of adjusting the distance between the head 36 and the support surface 29, the influence of the interference with the head 36 can be reduced. In this manner, even in the case where the size of the printing apparatus 10 is reduced, the reliability of detection of the interference with the head 36 can be increased.

### Modifications

The embodiments may be modified as follows for implementation. The embodiments and modifications described below may be combined for implementation insofar as they are not technically inconsistent.
In the interference detection processing of the second embodiment, in step S36, the control unit 53 may control the support surface 29 to move to the lower side Z2 with a distance including the prescribed distance as the set distance. In this case, the control unit 53 may not execute steps S25 and S30. In this manner, the control unit 53 may move the support surface 29 to the lower side Z2 with a distance not including the prescribed distance as the set distance, or move the support surface 29 to the lower side Z2 with a distance including the prescribed distance as the set distance.
The control unit 53 may switch the first control of the first embodiment and the second control of the second embodiment in accordance with the user operation. Specifically, the control unit 53 may execute, as a first control, a control of adjusting the distance between the head 36 and the support surface 29 as a result of detecting the interference with the head 36 in linkage with the movement of the head 36 to the front side Y1. The control unit 53 may execute, as a second control, a control of detecting the interference with the head 36 in linkage with the movement of the head 36 to the front side Y1 in the state where the support surface 29 is moved to the lower side Z2 by the set distance set by the user.
The control unit 53 may detect the interference with the head 36 with the second interference detection unit 63 by moving the head 36 from the first initial movement position to the second initial movement position without moving the support surface 29 to the lower side Z2 by a prescribed distance.
The distance between the optical axis 63C of the second interference detection unit 63 and the support surface 29 in the vertical direction Z may be greater than the distance between the optical axis 62C of the first interference detection unit 62 and the support surface 29 in the vertical direction Z. The distance between the optical axis 63C of the second interference detection unit 63 and the support surface 29 in the vertical direction Z may be the same as the distance between the optical axis 62C of the first interference detection unit 62 and the support surface 29 in the vertical direction Z.
At least any of the first interference detection unit 62 and the second interference detection unit 63 may be directly or indirectly supported by the second moving unit 43 as long as it can be linked with the movement the second moving unit 43.
The control unit 53 may determine that there is an interference error when the distance between the head 36 and the support surface 29 reaches the upper limit. The control unit 53 may not determine that there is an interference error when printing on the medium is performed for a subsequent layer and an interference is detected by the first interference detection unit 62 or the second interference detection unit 63.
In plan view, the first opening 20 may have a shape having the same length as the support surface 29 in the front-rear direction Y, or may have a shape longer than the support surface 29 in the front-rear direction Y. In plan view, the first opening 20 may have a shape having the same length as the support surface 29 in the width direction X, or may have a shape shorter than the support surface 29 in the width direction X.
The first opening 20 and the second opening 21 need not necessarily be continuous with each other and may be provided separately from each other. The opening 19 need not necessarily be provided across the top surface 16 and the front surface 12.
The opening 19 may be provided across the top surface 16, the front surface 12, and the other surfaces. In other words, the opening 19 may be provided across at least the top surface 16 and the front surface 12. The opening 19 may be provided at the top surface 16 and not be provided at the front surface 12. In other words, it is only required that the opening 19 be provided at least at the top surface 16.
The support surface 29 is configured not to move in the horizontal direction. However, for example, the support surface 29 may be finely adjustable in the horizontal direction only when printing is not being performed, and it is only required that the support surface 29 be configured not to move in the horizontal direction at least when printing is being performed.
The second opening/closing cover 24 may maintain a constant angle with respect to the first opening/closing cover 23 without rotating with respect to the first opening/closing cover 23. In other words, the second opening/closing cover 24 may be not configured to be foldable with respect to the first opening/closing cover 23.
When maintenance is performed in the state where the printing is not being performed, the position adjusting unit 64 may move the support surface 29 from the placement position to the printing position. When maintenance such as flushing is performed in the state where the printing is being performed, the position adjusting unit 64 may allow the support surface 29 to remain at the printing position.
When the opening/closing cover 22 sets the opening 19 to the open state, the position adjusting unit 64 may adjust the position of the support surface 29 in the vertical direction Z from the printing position to the placement position. When the opening/closing cover 22 sets the opening 19 to the closed state, the position adjusting unit 64 may adjust the position of the support surface 29 in the vertical direction Z to the placement position to the printing position.
In the single print command, the printing unit 35 may perform printing when the head 36 is moved a plurality of times in the front-rear direction Y, and may perform printing when the head 36 is moved once in the front-rear direction Y.
The printing unit 35 may perform printing when the head 36 moves to either one of the front side Y1 and the rear side Y2, or may perform printing both when the head 36 moves to the front side Y1 and when the head 36 moves to the rear side Y2.
The printing unit 35 may perform printing when the head 36 moves in any one of the first width direction X1 and the second width direction X2, or may perform printing both when the head 36 moves in the first width direction X1 and when the head 36 moves in the second width direction X2.
The head 36 may include the nozzle surface 38 that is parallel to the horizontal plane or may include the nozzle surface 38 that is inclined with respect to the horizontal plane.
The maintenance unit 47 need not necessarily include at least one of the flushing portion 48, the wiping unit 49, the suction portion 50, and the waste liquid tank 51.
The printing apparatus 10 may not include the standby position detection unit 57 as long as the first movement position detection unit 58 is capable of detecting that the head 36 is arranged at the standby position. The printing apparatus 10 may not include the front position detection unit 59 as long as the second movement position detection unit 61 is capable of detecting that the head 36 is arranged at the front-most position. The printing apparatus 10 may not include the rear position detection unit 60 as long as the second movement position detection unit 61 is capable of detecting that the head 36 is arranged at the rear-most position.
The relationship between the width direction X and the front-rear direction Y in the present exemplary embodiment may be switched. In other words, the width direction X of the present exemplary embodiment may be the front-rear direction Y, and the front-rear direction Y of the present exemplary embodiment may be the width direction X.
For example, the medium is not limited to the T-shirt, a polo shirt, or the like, and may be a sweatshirt, a hooded sweatshirt, or the like, for example, or may be a medium such as clothing. Further, the medium having flexibility is adopted as the medium, but the medium is not limited to this example, and a medium having no flexibility, such as a smartphone case printed using UV ink, may be adopted, for example.
The printing apparatus 10 may be configured to eject ink as an example of the liquid, but may be configured to eject a liquid other than ink.
In other words, the liquid can be selected as desired as long as it can perform printing on the medium by adhering to the medium.

The expression “at least one of” used in the specification means one or more of desired options. As an example, when the number of options is two, the expression “at least one of” used in the specification means only one option or both of the two options. As another example, when the number of options is three or more, the expression “at least one of” used in the specification means only one option or any combination of two or more options.

### Appendix

The following is a description of the technical ideas and their effects that can be grasped from the above-described embodiments and modifications.
(A) A printing apparatus includes a medium support unit including a support surface configured to support a medium, a head configured to eject liquid to the medium supported by the support surface, a first moving unit configured to move the head in a first direction parallel to the support surface, a second moving unit configured to move the head in a second direction, the second direction being parallel to the support surface and intersecting the first direction, a position adjusting unit configured to adjust a distance between the head and the support surface in a third direction intersecting the support surface, a first interference detection unit configured to detect interference with the head, and a second interference detection unit configured to detect interference with the head. The first interference detection unit and the second interference detection unit are linked to movement of the head in the second direction, the first interference detection unit is provided further on one side than the head in the second direction, and the second interference detection unit is provided further on the other side than the head in the second direction.

With this configuration, printing on the medium can be performed by moving the head in the first direction and the second direction parallel to the support surface, and the configuration of moving the medium support unit in the first direction and the second direction is not required. Thus, the size of the printing device can be reduced.

In addition, in the third direction that intersects the support surface, the distance between the head and the support surface is adjusted. The first interference detection unit and the second interference detection unit are linked to the movement of the head in the second direction. The first interference detection unit is provided further on one side than the head in the second direction. The second interference detection unit is provided further on the other side than the head in the second direction. In this manner, the first interference detection unit is capable of detecting the interference with the head in linkage with the movement of the head to one side in the second direction, whereas the second interference detection unit is capable of detecting the interference with the head in linkage with the movement of the head to the other side in the second direction. Thus, the reliability of the detection of the interference with the head can be increased even in the case where the size of the printing apparatus is reduced.
(B) The above-described printing apparatus may further include a carriage configured to support the head. The carriage may be movable in the first direction, and includes one end on one side in the second direction, and the other end on the other side in the second direction, the first interference detection unit may be provided further on the other side than the one end of the carriage in the second direction, and the second interference detection unit may be provided on the one side than the other end of the carriage in the second direction. Specifically, as viewed from the third direction, the first interference detection unit may be provided further on one side than the head in the second direction between one end of the carriage and the head. In addition, as viewed from the third direction, the second interference detection unit may be provided further on the other side than the head in the second direction between the other end of the carriage and the head.

With this configuration, between one end and the other end of the carriage in the second direction, the first interference detection unit may be provided further on one side in the second direction, and the second interference detection unit may be provided further on the other side of the head in the second direction. In this manner, the first interference detection unit and the second interference detection unit may be provided within a range where the carriage is present in the second direction. Thus, the reliability of the detection of the interference with the head can be increased even in the case where the size of the printing apparatus is reduced.
(C) In the above-described printing apparatus, the first interference detection unit may include a first light emission unit and a first light reception unit, and detects interference with the head based on whether light emitted from the first light emission unit is received by the first light reception unit, the second interference detection unit may include a second light emission unit and a second light reception unit, and detects interference with the head based on whether light emitted from the second light emission unit is received by the second light reception unit, the first light emission unit may be provided further on one side than the support surface in the first direction, the first light reception unit may be provided further on the other side than the support surface in the first direction, the second light emission unit may be provided further on the other side than the support surface in the first direction, and the second light reception unit may be provided further on one side than the support surface in the first direction.

With this configuration, the light emitted from the first light emission unit to the first light reception unit less easily enters the second light reception unit, and the light emitted from the second light emission unit to the second light reception unit less easily enters the first light reception unit. In this manner, the interference with the head can be accurately detected. Thus, the reliability of the detection of the interference with the head can be increased even in the case where the size of the printing apparatus is reduced.
(D) In the above-described printing apparatus, a distance between an optical axis of the second interference detection unit and the support surface in the third direction may be smaller than a distance between an optical axis of the first interference detection unit and the support surface in the third direction.

With this configuration, the detection of the interference with the head at the second interference detection section can be performed at a timing earlier than the detection of the interference with the head at the first interference detection section. In this manner, the timing of the detection of the interference with the head can be adjusted in accordance with the detection state. Thus, the reliability of the detection of the interference with the head can be increased even in the case where the size of the printing apparatus is reduced.
(E) In the above-described printing apparatus, the first interference detection unit and the second interference detection unit may be supported by the second moving unit.

With this configuration, the interference with the head can be accurately detected with a simple configuration. Thus, the reliability of the detection of the interference with the head can be increased even in the case where the size of the printing apparatus is reduced.
(F) The above-described printing apparatus may further include a control unit configured to control the first moving unit, the second moving unit and the position adjusting unit. the head may be configured to standby in a standby position, the standby position may be located on the other side than the support surface in the second direction, when the first interference detection unit detects interference with the head when the head is moved to the one side in the second direction, the control unit may control the position adjusting unit to increase the distance between the support surface and the head, and when the second interference detection unit detects interference with the head when the head is moved to the other side in the second direction, the control unit may determine that there is an error.

With this configuration, when the head is moved to one side in the second direction, the distance between the head and the medium is adjusted by increasing the distance between the support surface and the head, whereas when the head is moved to the other side in the second direction, the determination of an error can be achieved. In this manner, the details of the control related to the detection of the interference with the head can be adjusted in accordance with the detection state. Thus, the reliability of the detection of the interference with the head can be increased even in the case where the size of the printing apparatus is reduced.

What is claimed is:

1. A printing apparatus comprising:
a medium support unit including a support surface configured to support a medium;
a head configured to eject liquid to the medium supported by the support surface;
a first moving unit configured to move the head in a first direction parallel to the support surface;
a second moving unit configured to move the head in a second direction, the second direction being parallel to the support surface and intersecting the first direction;
a position adjusting unit configured to adjust a distance between the head and the support surface in a third direction intersecting the support surface;
a first interference detection unit configured to detect interference with the head; and
a second interference detection unit configured to detect interference with the head, wherein
the first interference detection unit and the second interference detection unit are linked to movement of the head in the second direction,
the first interference detection unit is provided further on one side than the head in the second direction, and
the second interference detection unit is provided further on the other side than the head in the second direction.

2. The printing apparatus according to claim 1, further comprising a carriage configured to support the head, wherein
the carriage is movable in the first direction, and includes one end on one side in the second direction, and the other end on the other side in the second direction,
the first interference detection unit is provided further on the other side than the one end of the carriage in the second direction, and
the second interference detection unit is provided on the one side than the other end of the carriage in the second direction.

3. The printing apparatus according to claim 1, wherein
the first interference detection unit includes a first light emission unit and a first light reception unit, and detects interference with the head based on whether light emitted from the first light emission unit is received by the first light reception unit,
the second interference detection unit includes a second light emission unit and a second light reception unit, and detects interference with the head based on whether light emitted from the second light emission unit is received by the second light reception unit,
the first light emission unit is provided further on one side than the support surface in the first direction,
the first light reception unit is provided further on the other side than the support surface in the first direction,
the second light emission unit is provided further on the other side than the support surface in the first direction, and
the second light reception unit is provided further on one side than the support surface in the first direction.

4. The printing apparatus according to claim 3, wherein a distance between an optical axis of the second interference detection unit and the support surface in the third direction is smaller than a distance between an optical axis of the first interference detection unit and the support surface in the third direction.

5. The printing apparatus according to claim 1, wherein the first interference detection unit and the second interference detection unit are supported by the second moving unit.

6. The printing apparatus according to claim 1, further comprising a control unit configured to control the first moving unit, the second moving unit and the position adjusting unit, wherein
the head is configured to standby in a standby position,
the standby position is located on the other side than the support surface in the second direction,
when the first interference detection unit detects interference with the head when the head is moved to the one side in the second direction, the control unit controls the position adjusting unit to increase the distance between the support surface and the head, and
when the second interference detection unit detects interference with the head when the head is moved to the other side in the second direction, the control unit determines that there is an error.
